(19) United States
(12) Patent Application Publication
(10) Pub. No.: US 2004/0222267 A1
(43) Pub. Date: Nov. 11, 2004

(54) Kitchen appliance

(76) Inventors: Marko Areh, Radlje Ob Dravi (SI); Peter Brezovnik, Mozirje (SI); Henrik Pavlovic, Ljubno Ob Savinji (SI); Michael Steffl, Marquartstein (DE); Igor Zibret, Smartno Ob Paki (SI)

Correspondence Address: LERNER AND GREENBERG, PA, P O BOX 2480, HOLLYWOOD, FL, 33022-2480, US

(21) Appl. No.: 10/791,530

(22) Filed: Mar. 1, 2004

Related U.S. Application Data
(63) Continuation of application No. PCT/EP02/09464, filed on Aug. 23, 2002.

(30) Foreign Application Priority Data
Aug. 30, 2001 (DE) 101 42 501.5

(51) Int. Cl. A47J 37/12

(52) U.S. Cl. 227/127; 99/492

(57) ABSTRACT

A motorized kitchen appliance, especially a fruit press, includes a drive shaft which is prevented from being pulled out by a circlip that is mounted in a bead on the drive shaft. The circlip is prevented from rotating through the use of two legs and a housing part, that is a rod, which engages between the legs.

### CROSS-REFERENCE TO RELATED APPLICATION

This application is a continuation, under 35 U.S.C. § 120, of copending International Application No. PCT/EP02/09464, filed Aug. 23, 2002, which designated the United States; this application also claims the priority, under 35 U.S.C. § 119, of German Patent Application 101 42 501.5, filed Aug. 30, 2001; the prior applications are herewith incorporated by reference in their entirety.

### BACKGROUND OF THE INVENTION

### Field of the Invention

The present invention relates to a motorized kitchen appliance, in particular a fruit press, with a rotating element, in particular an element protruding from a collection bin, for pressing a half of a fruit containing juice. The rotating element is driven by a drive shaft, which is mounted in a housing part.

European Patent 0 362 058 B1 discloses a fruit press driven by an electromotor. A collection bin and a collection dish are accommodated in a housing. A drive shaft which projects through the middle of the collection dish sets the protruding element in rotation, along with the collection bin. The drive shaft is driven by the electromotor by way of belt pulleys and a toothed belt. The device is relatively complicated.

### SUMMARY OF THE INVENTION

It is accordingly an object of the invention to provide a motorized kitchen appliance, which overcomes the hereinafore-mentioned disadvantages of the heretofore-known devices of this general type and which is constructed in a simple manner.

With the foregoing and other objects in view there is provided, in accordance with the invention, a motorized kitchen appliance, especially a fruit press. The appliance comprises a housing part, and a drive shaft mounted in the housing part. A rotating element, in particular protruding from a collection bin, is driven by the drive shaft for pressing a half of a fruit containing juice. A circlip has a protruding wire, for securing the drive shaft against movement of the drive shaft in longitudinal direction of the drive shaft relative to the housing part.

The circlip constitutes axial securing. When the drive shaft is displaced against the force of a compression spring in the direction of its longitudinal axis, which is the case for example with a fruit press, the element receiving the fruit to be squeezed is depressed by the fruit placed thereon. The element is substantially in the form of a rotation paraboloid. The displacement closes an electric circuit in which the electric drive motor is connected. It is therefore necessary for the drive shaft to be able to be moved over a certain range in the longitudinal direction. That requires the use of a safety clamp mechanism, delimiting the stroke of the drive shaft in the longitudinal direction.

In accordance with the prior art, Seeger rings are used for that purpose. In contrast to known Seeger rings, the clamping device of the present invention does not rotate and therefore causes no friction to housing parts, in particular plastic housing parts that could be worn by the friction. The clamping device at the same time functions as an axial bearing. A washer is not required.

A particular advantage of the invention is that the clamping mechanism can be easily mounted and dismounted. Mounting and dismounting are possible manually without the use of tools.

In accordance with another feature of the invention, the circlip is held resiliently or elastically in a bead in the drive shaft.

In accordance with a further feature of the invention, the wire is formed by two legs of the circlip, between which a housing part engages.

In accordance with a concomitant feature of the invention, the housing part is disposed under a housing part having a gear.

Other features which are considered as characteristic for the invention are set forth in the appended claims.

Although the invention is illustrated and described herein as embodied in a kitchen appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, longitudinal-sectional view of a housing of a fruit press with a circlip; and

FIG. 2 is a plan view of the circlip of FIG. 1.

### DESCRIPTION OF THE PREFERRED EMBODIMENTS

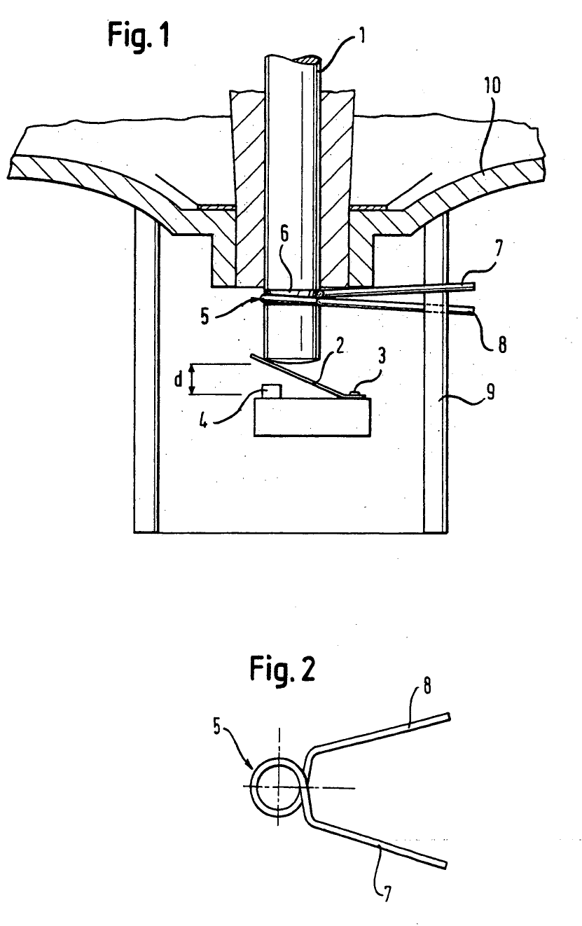

Referring now to FIGS. 1 and 2 of the drawings as a whole, there is seen a fruit press which has a drive shaft 1, the purpose of which is to set in rotation an element for the pressing of a citrus fruit. The drive shaft 1 is driven by an electromotor, which is connected through a drive shaft and meshing toothed wheels to the drive shaft 1. The drive shaft 1 is borne, for example, by non-illustrated friction bearings, and can be displaced in the axial direction against the spring force of a compression spring 2, which is constructed as a leaf spring attached at one side to an attachment location 3. The drive shaft 1 can be displaced through the use of the compression spring 2 in the axial direction over a distance d against a key 4 for closing an electric circuit including the electromotor.

A circlip 5, such as a clamping or locking ring, is clamped in a bead or crease 6 on the drive shaft 1. The circlip 5 is provided to prevent the drive shaft 1 from being pulled out. The circlip 5 has at least one wire or leg 7, 8, by which it can easily be grasped by hand to insert it into the bead 6 or withdraw it therefrom. The legs 7 and 8 are bent away from each other at an acute angle, for example approximately 30°.

A housing part, which in this case is in the form of a rod 9 extending substantially parallel to the longitudinal axis of the drive shaft 1, is clamped between the legs 7 and 8. This securing ensures, on one hand, that the drive shaft 1 cannot be pulled up out of its seat and, on the other hand, that no plastic housing part can be worn by friction with a securing ring when the drive shaft 1 rotates, and accordingly damaged, because the circlip 5 is fixed in place by mounting with the rod 9.

The invention provides a drive shaft 1 for an electric kitchen appliance, which is prevented from being pulled out. For this purpose, it has a circlip 5 mounted in a bead 6 on the drive shaft 1. The circlip 5 is secured against rotation by the housing part, that is the rod 9. More specifically, the circlip 5 is secured through two legs 7, 8 against rotation by the housing part, that is, the rod 9, which engages between the legs 7, 8. The rod or housing part 9 is connected to a floor part 10 of the housing accommodating a gear and disposed substantially horizontally about the drive shaft 1. The floor part 10 of the housing is a rotating element protruding from and representing a collection bin provided for pressing a half of a fruit containing juice.

We claim:

1. A motorized kitchen appliance, comprising:
a housing part;
a drive shaft mounted in said housing part;
a rotating element driven by said drive shaft; and
a circlip having a protruding wire, for securing said drive shaft against movement of said drive shaft in longitudinal direction of said drive shaft relative to said housing part.

2. The kitchen appliance according to claim 1, wherein said circlip is held resiliently in a bead formed in said drive shaft.

3. The kitchen appliance according to claim 1, wherein said wire is formed by two legs of said circlip between which said housing part engages.

4. The kitchen appliance according to claim 1, wherein said housing part is disposed under said rotating element, and said rotating element is another housing part accommodating a gear.

5. A motorized kitchen fruit press, comprising:
a housing part;
a drive shaft mounted in said housing part;
a rotating element protruding from a collection bin and driven by said drive shaft for pressing a half of a fruit containing juice; and
a circlip having a protruding wire, for securing said drive shaft against movement of said drive shaft in longitudinal direction of said drive shaft relative to said housing part.
